(19) United States
(12) Patent Application Publication
(10) Pub. No.: US 2026/0296947 A1
(43) Pub. Date: Oct. 1, 2026

(54) METHOD OF MANUFACTURING AN OPTICAL FIBER PREFORM USING AIR FLOW TO REMOVE DEBRIS GENERATED DURING LASER WELDING AND SYSTEM FOR PERFORMING THE METHOD

(71) Applicant: CORNING INCORPORATED, CORNING, NY (US)

(72) Inventors: Anatoli Anatolyevich Abramov, Painted Post, NY (US); Christopher Charles Chilson, Wellsboro, PA (US)

(21) Appl. No.: 19/573,222

(22) Filed: Mar. 20, 2026

Related U.S. Application Data
(60) Provisional application No. 63/780,893, filed on Mar. 31, 2025.

(51) Int. Cl. C03B 37/012

(52) U.S. Cl. CPC C03B 37/01257; C03B 37/0126

(57) ABSTRACT

A method of manufacturing a fiber preform includes (a) a gas flow step that includes introducing gas to flow through one or more of an outer preform cladding and an inner preform tube of a fiber preform workpiece at a first preform end of the fiber preform workpiece; and (b) a laser welding step, occurring simultaneously with the gas flow step, the laser welding step including directing a welding emission from a laser into the fiber preform workpiece proximate a second preform end, the welding emission increasing temperature and reducing viscosity of the outer preform cladding and one of the inner preform tubes sufficiently for a laser weld volume to form that fuses the outer preform cladding and the inner preform tube together. A system to perform the method is additionally disclosed.

This Application claims the benefit of priority to U.S. Provisional Patent Application Ser. No. 63/780893 filed on Mar. 31, 2025, the content of which is relied upon and incorporated herein by reference in its entirety.

### TECHNICAL FIELD

The present disclosure pertains to a method of manufacturing a preform for a hollow core optical fiber and related system and, more particularly, to causing gas to flow through the preform while laser welding is occurring to fuse an inner preform tube to an outer preform cladding in order to prevent deposit of debris within the preform.

### BACKGROUND

An optical fiber can be utilized to transmit an electromagnetic radiation signal across a distance. In a traditional design, the optical fiber includes a solid core through which the signal transmits and a solid cladding disposed radially around the solid core. The solid core and the solid cladding have different indices of refraction. The signal thus largely stays confined within the solid core during transmission because of total internal reflection at the interface between the solid core and the solid cladding. The utilization of the solid core limits the speed at which the optical fiber can transmit the signal (e.g., an inherent minimum latency), limits the power of the signal that can be transmitted, imposes a degree of attenuation of the signal, and introduces non-linear effects such as four-wave mixing.

To address the limitations of the solid core based optical fiber, optical fibers with a hollow core have been proposed. With such an optical fiber, there is no solid core but rather a hollow core. Various ways of maintaining the signal within the hollow core have been utilized-one of which is anti-resonance. With anti-resonance, the cladding is engineered with the operating wavelength of the signal in mind so that the cladding reflects the signal back into the hollow core and largely prevents transmission of the signal through the cladding. An example of such a cladding are hollow tubes that run axially with the transmission axis through the hollow core. The hollow tubes are placed radially around the transmission axis to define the hollow core and have a thickness at which the resonance of the signal with the hollow tubes does not occur so that coupling of the signal with modes of the cladding does not occur and the signal remains confined to the hollow core. Such optical fibers are typically referred to as anti-resonant hollow core optical fibers or ARFs for short.

Techniques to manufacture ARFs are under development. However, like solid core optical fibers, the techniques typically all include drawing the ARF from a preform that is structurally similar to the AFR but with thicker components. Fabrication of the preform may require precise spatial placement of the preform cladding tubes relative to each other and a surrounding outer cladding. To obtain the precise spatial placement, it has been proposed to fuse the preform cladding tubes and the surrounding outer cladding together. Such fusion has heretofore been achieved using a CO₂ laser or an open flame to weld the components.

However, those manufacturing techniques cause various problems. First, use of the CO₂ laser and the open flame have both caused particle deposition on the preform components such as the preform cladding tubes and the preform outer cladding. As the CO₂ laser or the open flame causes the preform components to increase in temperature, particles of material such as silica soot are released. In the case of the open flame, the particles may include contaminants formed during combustion. The particles then deposit elsewhere on the components. The deposition of the particles is problematic because the particles may cause the optical fiber ultimately drawn from the preform to have defects or to exhibit suboptimal transmission and mechanical performance. The particles could be removed from the preform before an optical fiber is drawn from the preform. However, such remediation efforts are difficult to perform and, in any event, suboptimal in terms of cost and time.

Second, the use of the open flame poses additional problems in that the preform components can become distorted, a consequence of the open flame heating a relatively large volume of the preform components. The distortion can cause the preform components to become out of predetermined dimensional tolerances. The preform may then need to be scrapped. Even if not, the change in dimensional tolerances may be carried over to the optical fiber drawn from the preform, disturbing performance of the optical fiber.

### SUMMARY

The present disclosure addresses those problems with a method of, and a system for, manufacturing a fiber preform that directs gas into one end of the fiber preform while performing laser welding at the other end of the fiber preform. The flow of the gas toward the laser welding causes at least a portion of the debris that is generated during the laser welding to exit the fiber preform without redepositing thereon. Further, because a laser can be utilized, the issues with component distortion from open flame welding are avoided.

According to a first aspect of the present disclosure, a method of manufacturing a fiber preform comprises: (a) a gas flow step comprising introducing gas to flow through a fiber preform workpiece at a first preform end of the fiber preform workpiece, the fiber preform workpiece comprising inner preform tubes disposed within an outer preform cladding, the fiber preform workpiece further comprising a second preform end and a longitudinal axis extending from the first preform end to the second preform end; and (b) a laser welding step, occurring simultaneously with the gas flow step, the laser welding step comprising directing a welding emission from a laser into the fiber preform workpiece proximate the second preform end, the welding emission increasing temperature and reducing viscosity of the outer preform cladding and one of the inner preform tubes sufficiently for a laser weld volume to form that fuses the outer preform cladding and the one of the inner preform tubes together.

According to a second aspect of the present disclosure, the method of the first aspect is presented, wherein (i) the fiber preform workpiece further comprises nested preform capillaries, each of the nested preform capillaries disposed within a different one of the inner preform tubes, and (ii) during the gas flow step, the gas is introduced to flow through one or more of the outer preform cladding, the inner preform tubes, and the nested preform capillaries.

According to a third aspect of the present disclosure, the method of the second aspect is presented, wherein (i) the outer preform cladding has a cladding thickness, (ii) each of the inner preform tubes has a tube thickness, (iii) each of the nested preform capillaries has a capillary thickness, and (iv) the cladding thickness is greater than both the tube thickness and the capillary thickness.

According to a fourth aspect of the present disclosure, the method of any one of the first through third aspects is presented, wherein the outer preform cladding and the inner preform tubes all comprise one or more of silica, doped silica, fluorine-doped silica, fluorine-doped borosilicate glass, borosilicate glass, soda-lime glass, and aluminosilicate glass.

According to a fifth aspect of the present disclosure, the method of any one of the first through fourth aspects is presented, wherein during the gas flow step, the gas is caused to flow at a volumetric flow rate within a range of from 1.0 LPM to 5.0 LPM.

According to a sixth aspect of the present disclosure, the method of any one of the first through fifth aspects is presented, wherein during the gas flow step, the gas is caused to flow (i) into the fiber preform workpiece at the first preform end, (ii) along the longitudinal axis toward the second preform end, and (iii) out of the fiber preform workpiece at the second preform end.

According to a seventh aspect of the present disclosure, the method of any one of the first through sixth aspects is presented, wherein during the gas flow step, a source of suction with a suction inlet disposed proximate the second preform end is activated and accepts the gas that has flowed through the fiber preform workpiece.

According to an eighth aspect of the present disclosure, the method of the seventh aspect is presented, wherein during the laser welding step, the welding emission generates debris originating from the fiber preform workpiece, and the gas flowing through the fiber preform workpiece causes at least a portion of the debris to flow into the source of suction.

According to a ninth aspect of the present disclosure, the method of any one of the first through eighth aspects further comprises: (a) a workpiece azimuthal rotation step, occurring after a first performance of the gas flow step and the laser welding step, the workpiece azimuthal rotation step comprising rotating the fiber preform workpiece azimuthally about the longitudinal axis; and (b) a second performance of the gas flow step and the laser welding step, the second performance of the laser welding step resulting in the fusion of the outer preform cladding and a different one of the inner preform tubes together at a laser weld volume different than the laser weld volume at which the inner preform tube is fused to the outer preform cladding as a result of the first performance.

According to a tenth aspect of the present disclosure, the method of the ninth aspect is presented, wherein during the workpiece azimuthal rotation step, the longitudinal axis is oriented horizontally.

According to an eleventh aspect of the present disclosure, the method of the ninth aspect is presented, wherein during the workpiece azimuthal rotation step, the longitudinal axis is oriented vertically.

According to a twelfth aspect of the present disclosure, the method of the ninth aspect is presented, wherein during workpiece azimuthal rotation step, the longitudinal axis is oriented at an angle between horizontal and vertical.

According to a thirteenth aspect of the present disclosure, the method of any one of the first through twelfth aspects further comprises: (a) a workpiece axial rotation step, occurring after the gas flow step and the laser welding step, the workpiece axial rotation step comprising rotating the fiber preform workpiece 180 degrees about an axis orthogonal to the longitudinal axis; (b) a second performance of the gas flow step comprising introducing the gas at the second preform end to flow through the fiber preform workpiece; and (c) a second performance of the laser welding step, occurring simultaneously with the second gas flow step, the second laser welding step comprising directing a second welding emission from the laser into the fiber preform workpiece proximate the first preform end, the second welding emission increasing temperature and reducing viscosity of the outer preform cladding and one of the inner preform tubes sufficiently for a first laser weld volume to form that fuses the outer preform cladding and the inner preform tube together at the first preform end.

According to a fourteenth aspect of the present disclosure, a system for manufacturing a fiber preform comprises: (1) a workpiece support configured to support a fiber preform workpiece, the fiber preform workpiece comprising (a) a first preform end, a second preform end, and a longitudinal axis extending from the first preform end to the second preform end; (b) an outer preform cladding through which the fiber longitudinal axis extends, the outer preform cladding comprising an inner cladding surface facing and disposed radially around the longitudinal axis; and (c) inner preform tubes coupled to the outer preform cladding at the inner cladding surface of the outer preform cladding, each of the inner preform tubes comprising (i) a tube axis extending therethrough parallel to the longitudinal axis of the fiber preform workpiece, (ii) an inner tube surface extending radially around the tube axis, and (iii) an outer tube surface facing away from the tube axis, and wherein the inner preform tubes collectively defining a preform core that extends radially from the longitudinal axis and that is tangential to the outer tube surface of each of the inner preform tubes; (2) a laser configured to generate a welding emission, the laser positioned to direct the welding emission into one of the inner preform tubes of the fiber preform workpiece proximate the second preform end; and (3) at least one of: (a) an outlet in fluid communication with a source of gas, the outlet positioned to introduce gas of the source of gas to flow through one or more of the outer preform cladding and the inner preform tubes of the fiber preform workpiece at the first preform end; and (b) a suction inlet in fluid communication with a source of suction, the suction inlet positioned to be proximate the second preform end and, when activated, to draw in at least a portion of the gas that has flowed through the one or more of the outer preform cladding and the inner preform tubes.

According to a fifteenth aspect of the present disclosure, the system of the fourteenth aspect further comprises: a filter in fluid communication with and between the source of the gas and the outlet.

According to a sixteenth aspect of the present disclosure, the system of any one of the fourteenth through fifteenth aspects further comprises: (a) a manifold in fluid communication with and between the source of the gas and the outlet; (b) needles in fluid communication with the manifold, each of the needles positioned to extend parallel to the longitudinal axis of the fiber preform workpiece and collectively defining the outlet; and (c) a base mover configured to move the base of the workpiece support relative to the needles parallel to the longitudinal axis of the fiber preform workpiece so that the needles transition to, from, and between (i) a retracted position where the needles do not extend into the fiber preform workpiece and (ii) an inserted position where the needles are disposed within one or more of a cladding interior of the outer preform cladding and a tube interior of the inner preform tube subjected to the laser welding step.

According to a seventeenth aspect of the present disclosure, the system of any one of the fourteenth through sixteenth aspects is presented, wherein the laser is positioned to emit the welding emission at an acute angle relative to the tube axis of the inner preform tube that the welding emission is affecting to form the laser weld volume.

According to an eighteenth aspect of the present disclosure, the system of any one of the fourteenth through seventeenth aspects further comprises both (i) the outlet and (ii) the suction inlet in fluid communication with the source of suction.

According to a nineteenth aspect of the present disclosure, the system of any one of the fourteenth through eighteenth aspects is presented, wherein the workpiece support comprises an azimuthal rotation member that is configured to rotate the fiber preform workpiece azimuthally about the longitudinal axis to align another one of the inner preform tubes to receive a welding emission from the laser.

According to a twentieth aspect of the present disclosure, the system of any one of the fourteenth through nineteenth aspects is presented, wherein the workpiece support is configured (i) to support multiple fiber preform workpieces, each of the multiple fiber preform workpieces evenly spaced around a support axis and (ii) to rotate about the support axis to place, in sequence, each of the multiple fiber preform workpieces in position relative to the laser to receive a welding emission.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiments, and together with the description serve to explain principles and operation of the various embodiments.

### BRIEF DESCRIPTION OF THE DRAWINGS

In the Drawings:

FIG. 1 is a perspective view of a fiber preform, illustrating an outer preform cladding, inner preform tubes fused to an inner cladding surface of the outer preform cladding, and optionally nested preform capillaries fused to an inner tube surface of the inner preform tubes;

FIG. 2 is an elevation view of the fiber preform, illustrating the inner preform tubes defining a preform core;

FIG. 3 is an elevation view of a cross-section of the fiber preform taken along line III-III of FIG. 2, illustrating (i) a first laser weld volume fusing one of the preform capillaries, one of the inner tubes, and the outer preform cladding together at a first preform end of the fiber preform and (ii) a second laser weld volume fusing one of the preform capillaries, one of the inner tubes, and the outer preform cladding together at a second preform end of the fiber preform;

FIG. 4 is an elevation view of a cross-section of the fiber preform taken along line IV-IV of FIG. 2, illustrating (i) a first laser weld volume fusing one of the inner tubes and the outer preform cladding together at the first preform end of the fiber preform and (ii) a second laser weld volume fusing one of the inner tubes and the outer preform cladding together at the second preform end of the fiber preform (it should be understood that FIGS. 3 and 4 show different embodiments of the fiber preform);

FIG. 5 is a schematic diagram of a method of manufacturing the fiber preform, illustrating repeated performances of an air flow step, a laser welding step (occurring simultaneously with the air flow step), a workpiece azimuthal rotation step, and a workpiece axial rotation step until all of the inner preform tubes have been fused to the outer preform cladding via first laser weld volumes at the first preform end and second laser weld volumes at the second preform end;

FIG. 6 is a schematic diagram of a system to perform the method, illustrating a workpiece support to support a fiber preform workpiece (a precursor to the fiber preform), (i) for the air flow step, a source of gas in fluid communication with an outlet at the first preform end to direct the gas to flow into the fiber preform workpiece such as into a cladding interior of the outer preform cladding and at least a tube interior of one of the inner preform tubes to be subjected to the laser welding step, and (ii) for the laser welding step, a laser to direct a welding emission into the inner preform tube at the second preform end to form the second laser weld volume fusing the inner preform tube and the outer preform cladding together;

FIG. 7 is an elevation view of the fiber preform workpiece illustrating a cylindrical insert at the first preform end to stabilize the inner preform tubes until the laser welding step has been performed;

FIG. 8 is a schematic diagram of an embodiment of the system, illustrating a manifold in fluid communication between the source of the gas and needles collectively forming the outlet for use in the gas flow step, the needles in an inserted position (top) inside of the fiber preform workpiece, and the needles in a retracted position (bottom) outside of the fiber preform workpiece;

FIG. 9 is a schematic diagram of an aspect of the method, illustrating (i) on the left, a first performance of the gas flow step and the laser welding step to fuse one of the inner preform tubes and the outer preform cladding together, (ii) in the middle, the workpiece axial rotation step occurring to place another inner preform tube in correct alignment with the laser, and (iii) on the right, a second performance of the gas flow step and the laser welding step to fuse the newly aligned one of the inner preform tubes and the outer preform cladding together;

FIG. 10 is a schematic diagram of an embodiment of the workpiece support that supports multiple fiber preform workpieces and can rotate the fiber preform workpieces collectively and each individual fiber preform workpiece to align any given of the inner preform tubes with the laser for performances of the laser welding step and the gas flow step;

FIG. 11, pertaining to Example 1, are a pair of images showing the system and the method in process, with the gas flow step shown in both images and additionally the laser welding step shown on the right;

FIG. 12, pertaining to Example 2, is an image showing the laser welding step and the gas from the gas flow step being sucked towards a suction inlet along with debris.

### DETAILED DESCRIPTION

Reference will now be made in detail to the present preferred embodiments, examples of which are illustrated in the accompanying drawings. Whenever possible, the same reference numerals will be used throughout the drawings to refer to the same or like parts.

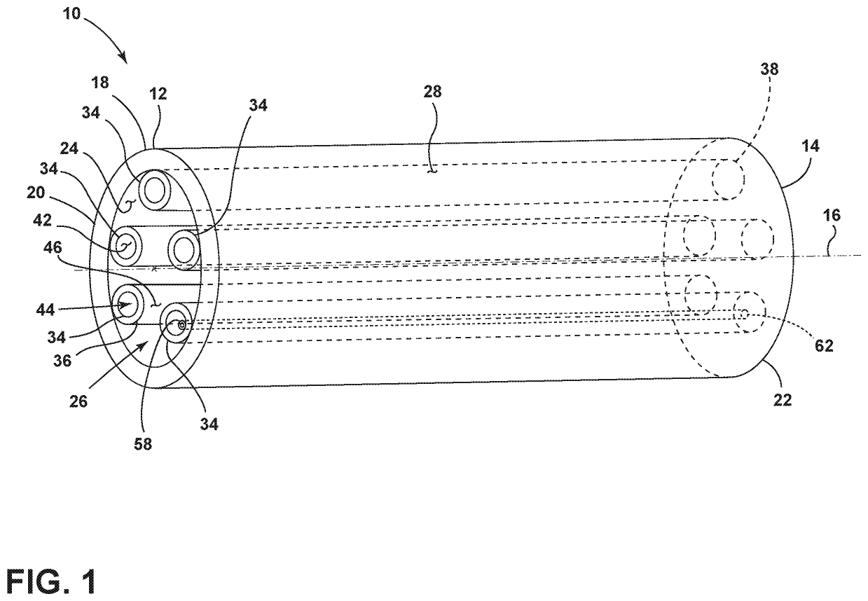

Referring to FIGS. 1-4, this disclosure relates to the manufacture of a fiber preform 10. The fiber preform 10 includes a first preform end 12 and a second preform end 14. The first preform end 12 and the second preform end 14 face in opposite directions. The fiber preform 10 further includes a longitudinal axis 16 that extends from the first preform end 12 to the second preform end 14.

The fiber preform 10 further includes an outer preform cladding 18. The longitudinal axis 16 extends through the outer preform cladding 18. The outer preform cladding 18 has a first cladding end 20 that may define at least in part the first preform end 12. The outer preform cladding 18 has a second cladding end 22 that may define at least in part the second preform end 14. The outer preform cladding 18 provides an inner cladding surface 24 that is disposed radially around the longitudinal axis 16. The inner cladding surface 24 faces the longitudinal axis 16. The inner cladding surface 24 defines a cladding interior 26 through which the longitudinal axis 16 extends. The inner cladding surface 24 can at least partially define the longitudinal axis 16 of the fiber preform 10. The outer preform cladding 18 further includes an outer cladding surface 28 that faces away from the longitudinal axis 16. The outer preform cladding 18 further includes a cladding thickness 30 that is measured radially relative to the longitudinal axis 16 between the inner cladding surface 24 and the outer cladding surface 28. In embodiments, the cladding thickness 30 is within a range of from 3 mm to 40 mm. For example, the cladding thickness 30 can be 3 mm, 5 mm, 7 mm, 10 mm, 15 mm, 20 mm, 25 mm, 30 mm, 35 mm, 40 mm, or within any range bound by any two of those values (e.g., from 5 mm to 15 mm, from 15 mm to 30 mm, and so on). The cladding thickness 30 could be less than 3 mm or greater than 40 mm, however the provided values are just exemplary. The outer preform cladding 18 can have an inner cladding radius 32 defined by the inner cladding surface 24 within a range of from 15.0 mm to 23.0 mm. For example, the inner cladding radius 32 can be 15.0 mm, 15.5 mm, 16.0 mm, 16.5 mm, 17.0 mm, 17.5 mm, 18.0 mm, 18.5 mm, 19.0 mm, 19.5 mm, 20.0 mm, 20.5 mm, 21.0 mm, 21.5 mm, 22.0 mm, 22.5 mm, 23.0 mm, or within any range bound by any two of those values (e.g., from 16.0 mm to 22.0 mm, from 16.5 mm to 19.0 mm, and so on).

The fiber preform 10 further includes inner preform tubes 34. The inner preform tubes 34 are at least partially disposed within the cladding interior 26 of the outer preform cladding 18. As will be discussed in greater detail herein, the inner preform tubes 34 are coupled to the outer preform cladding 18 at the inner cladding surface 24. Each of the inner preform tubes 34 has a first tube end 36 that may define at least in part the first preform end 12. Each of the inner preform tubes 34 has a second tube end 38 that may define at least in part the second preform end 14. Each of the inner preform tubes 34 has a tube axis 40 extending therethrough that is parallel to the longitudinal axis 16 of the fiber preform 10. Each of the inner preform tubes 34 provides an inner tube surface 42 that is disposed radially around the tube axis 40 thereof. The inner tube surface 42 defines a tube interior 44 through which the tube axis 40 extends. Each of the inner preform tubes 34 provides an outer tube surface 46 that faces away from the tube axis 40 thereof. The inner tube surface 42 and the outer tube surface 46 of each of the inner preform tubes 34 can extend from the tube axis 40 thereof at an outer tube radius 48 and an inner tube radius 50, respectively. The inner preform tubes 34 collectively define a preform core 52. The preform core 52 extends radially around the longitudinal axis 16 at a core radius 54. The preform core 52 is tangential to the outer tube surface 46 of each of the inner preform tubes 34. The inner preform tubes 34 may be equidistantly spaced from each other.

Each of the inner preform tubes 34 has a tube thickness 56, which may all be the same. The tube thickness 56 is measured radially relative to the tube axis 40 between the inner tube surface 42 and the outer tube surface 46. In embodiments, the cladding thickness 30 is greater than the tube thickness 56. In embodiments, the tube thickness 56 is within a range of from 0.5 mm to 2.0 mm. For example, the tube thickness 56 can be 0.5 mm, 0.6 mm, 0.7 mm, 0.8 mm, 0.9 mm, 1.0 mm, 1.1 mm, 1.2 mm, 1.3 mm, 1.4 mm, 1.5 mm, 1.6 mm, 1.7 mm, 1.8 mm, 1.9 mm, 2.0 mm, or within any range bound by any two of those values (e.g., from 0.7 mm to 1.5 mm, from 0.8 mm to 1.6 mm, and so on). The tube thickness 56 can be less than 0.5 mm or greater than 2.0 mm, however-those values are merely exemplary. In embodiments, the outer tube radius 48 is within a range of from 4.5 mm to 8.0 mm. For example, the outer tube radius 48 can be 4.5 mm, 5.0 mm, 5.5 mm, 6.0 mm, 6.5 mm, 7.0 mm, 7.5 mm, 8.0 mm or within any range bound by any two of those values (e.g., from 5.0 mm to 6.0 mm, from 6.0 mm to 7.0 mm, and so on). In embodiments, the inner tube radius 50 is within a range of from 4.50 mm to 7.50 mm. For example, the inner tube radius 50 can be 4.50 mm, 4.75 mm, 5.00 mm, 5.25 mm, 5.50 mm, 5.75 mm, 6.00 mm, 6.25 mm, 6.50 mm, 6.75 mm, 7.00 mm, 7.25 mm, 7.50 mm, or within any range bound by any two of those values (e.g., from 4.75 mm to 5.50 mm, from 5.25 mm to 6.00 mm, and so on).

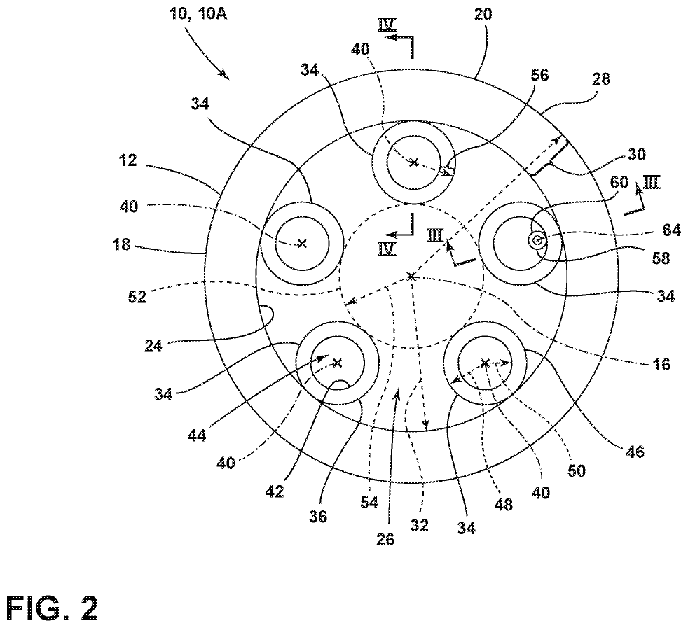

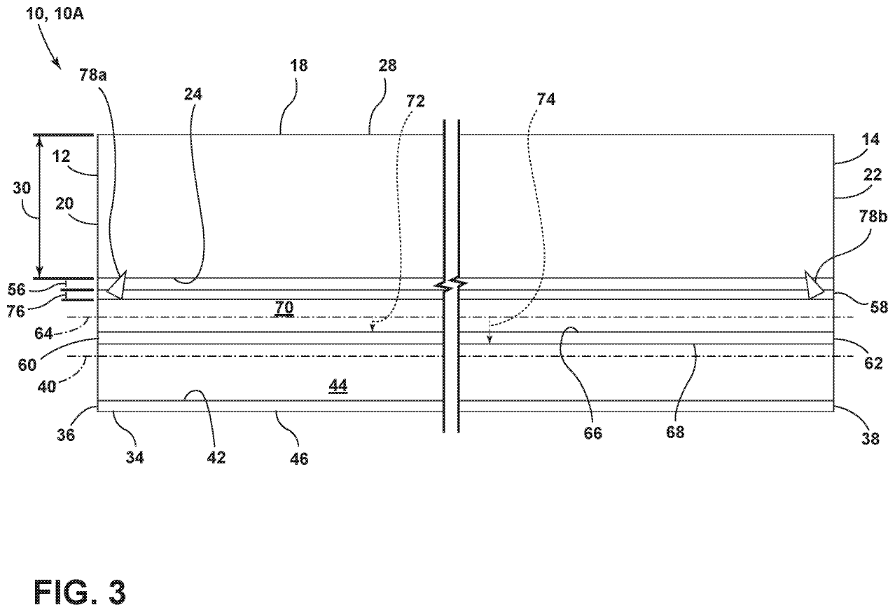

In embodiments, the fiber preform 10 further includes nested preform capillaries 58 (see FIGS. 2 and 3). The nested preform capillaries 58 are disposed within the inner preform tubes 34. More particularly, each of the nested preform capillaries 58 is disposed within the tube interior 44 of a different one of the inner preform tubes 34. Such an arrangement is sometimes referred to as a nested arrangement. Each of the nested preform capillaries 58 has a first capillary end 60 that may define at least in part the first preform end 12. Each of the nested preform capillaries 58 has a second capillary end 62 that may define at least in part the second preform end 14 of the fiber preform 10. Each of the nested preform capillaries 58 includes a capillary axis 64 extending therethrough. The capillary axis 64 is parallel to the longitudinal axis 16 of the fiber preform 10 and thus the tube axis 40. Each of the nested preform capillaries 58 further includes an inner capillary surface 66 and an outer capillary surface 68. The inner capillary surface 66 extends radially around the capillary axis 64 and defines a capillary interior 70, such as at an inner capillary radius 72 from the capillary axis 64. The outer capillary surface 68 faces away from the tube axis 40, such as at an outer capillary radius 74 from the capillary axis 64. Each of the nested preform capillaries 58 has a capillary thickness 76, which may all be the same. The capillary thickness 76 is measured radially relative to the tube axis 40 between the inner capillary surface 66 and the outer capillary surface 68 of the nested preform capillary 62. In embodiments, the capillary thickness 76 is within 10% of the tube thickness 56 of the inner preform tube 34, and may be equal to the tube thickness 56 to the extent achievable under manufacturing tolerances. However, in other embodiments, the capillary thickness 76 and the tube thickness 56 vary by more 10% or more, even 50% or more. In embodiments, the cladding thickness 30 is greater than the capillary thickness 76. In embodiments, the inner capillary radius 72 is within a range of from 1.75 mm to 3.75 mm. For example, the inner capillary radius 72 can be 1.75 mm, 2.00 mm, 2.25 mm, 2.50 mm, 2.75 mm, 3.00 mm, 3.25 mm, 3.50 mm, 3.75 mm, or within any range bound by any two of those values (e.g., from 2.00 mm to 3.50 mm, from 2.25 mm to 2.75 mm, and so on). In embodiments, the outer capillary radius 74 is within a range of from 2.25 mm to 4.25 mm. For example, the outer capillary radius 74 can be 2.25 mm, 2.50 mm, 2.75 mm, 3.00 mm, 3.25 mm, 3.50 mm, 3.75 mm, 4.00 mm, 4.25 mm, or within any range bound by any two of those values (e.g., from 3.00 mm to 3.50 mm, from 3.25 mm to 4.00 mm, and so on).

The outer preform cladding 18, the inner preform tubes 34, and the nested preform capillaries 58 (if included) each have a glass composition. Examples of suitable glass compositions include one or more of silica, doped silica, fluorine-doped silica, fluorine-doped borosilicate glass, borosilicate glass, soda-lime glass, and aluminosilicate glass.

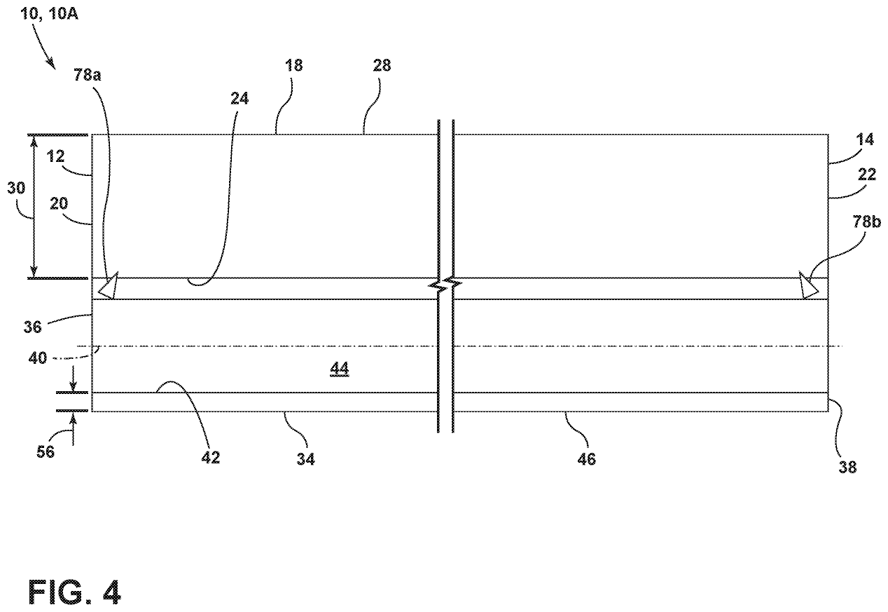

The fiber preform 10 further includes laser weld volumes 78, such as first laser weld volumes 78a and second laser weld volumes 78b (see FIGS. 3 and 4). Each of the first laser weld volumes 78a fuse a different one of the inner preform tubes 34 to the outer preform cladding 18 proximate the first preform end 12. Similarly, each of the second laser weld volumes 78b fuse a different one of the inner preform tubes 34 to the outer preform cladding 18 proximate the second preform end 14. In embodiments of the fiber preform 10 that include the nested preform capillaries 58, each of the first laser weld volumes 78a further fuse a different one of the nested preform capillaries 58 to the inner preform tube 34 within which the nested preform capillary 62 is disposed proximate the first preform end 12. Similarly, each of the second laser weld volumes 78b further fuse a different one of the nested preform capillaries 58 to the inner preform tube 34 within which the nested preform capillary 62 is disposed proximate the second preform end 14.

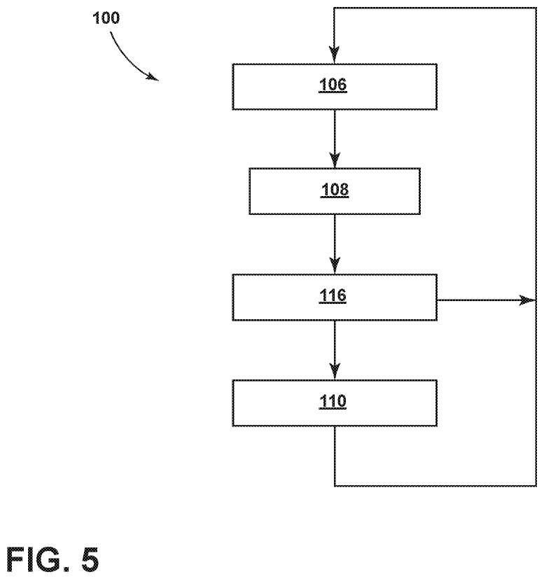

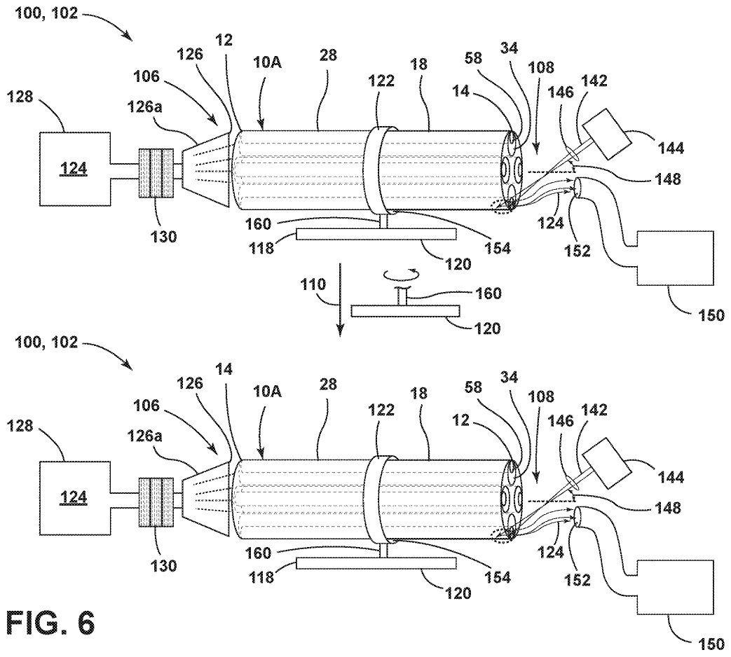

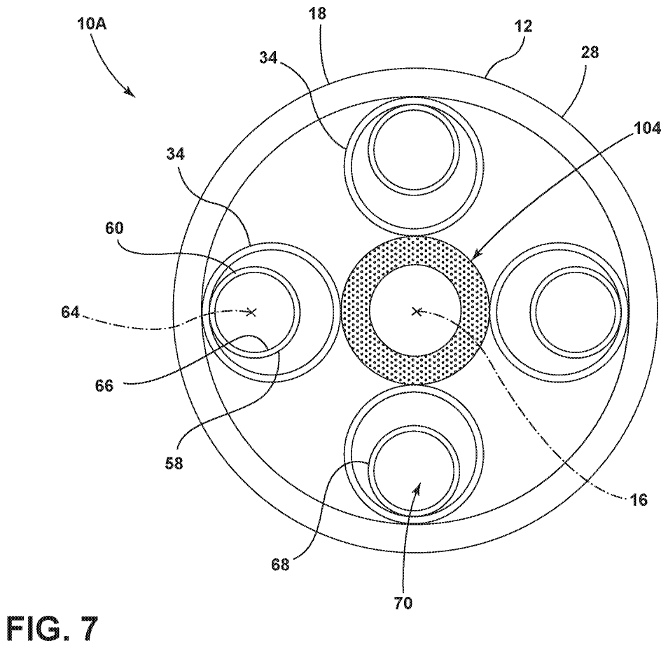

Referring now to FIGS. 5-10, a method 100 of manufacturing the fiber preform 10 and a system 102 (see FIG. 6) for manufacturing the fiber preform 10 from a fiber preform workpiece 10A are here disclosed. The fiber preform workpiece 10A is identical to the fiber preform 10 heretofore discussed with the exceptions (i) that the first laser weld volumes 78a and the second laser weld volumes 78b have not yet been formed and (ii) two cylindrical inserts 104 (see FIG. 7), one at the first preform end 12 and the other at the second preform end 14, with an outer radius matching the core radius 54 can be utilized to stabilize placement of the inner preform tubes 34 where laser welding is to occur. In an alternative embodiment, a single cylindrical inert 104 aligned with longitudinal axis 16 is utilized to stabilize placement of the inner preform tubes 34.

The method 100 includes at least a gas flow step 106 and a laser welding step 108. The method 100 further include one or more of a workpiece axial rotation step 110, a second gas flow step 112, a second laser welding step 114, and a workpiece azimuthal rotation step 116, as will be further detailed below. While the method 100 and the system 102 are discussed in the terms of manufacturing the fiber preform 10, it should be understood that the fiber preform 10 can take many different embodiments that those describe above. The fiber preform 10 described above is to facilitate understanding aspects of the method 100 and of the system 102 and is not intended as limiting the applicability of the system 102 and the method 100 described herein to any particular arrangement of the fiber preform 10.

The system 102 includes at least a workpiece support 118 (see FIG. 6). The workpiece support 118 is configured to hold the fiber preform workpiece 10A during performance of the method 100. No particular structure is required-the workpiece support 118 simply needs to be able to hold the fiber preform workpiece 10A in a desired position and, in embodiments, with the longitudinal axis 16 of the fiber preform workpiece 10A in a desired alignment, for example relative to horizontal or vertical. As an example, the workpiece support 118 includes a base 120 and a clamp 122 extending from the base 120. The clamp 122 extends around at least a portion of the outer cladding surface 28 of the outer preform cladding 18.

The gas flow step 106 includes introducing and cause gas 124 to flow into and through the fiber preform workpiece 10A at the first preform end 12. For example, the gas 124 can be caused to flow into and through one or more of the cladding interior 26 of the outer preform cladding 18, the tube interior 44 of one or more the inner preform tubes 34, and (if included) the capillary interior 70 of one or more of the nested preform capillaries 58 at the first preform end 12 of the fiber preform workpiece 10A. In general, the gas flow step 106 introduces and causes the gas 124 to flow into and through at least the cladding interior 26 and the tube interior 44 of the inner preform tube 34 being subjected to the laser welding step 108. To accommodate, the system 102 can include an outlet 126 from a source 128 of the gas 124. The outlet 126 is in fluid communication with the source 128. The outlet 126 is positioned to introduce and cause the gas 124 to flow into the one or more of the cladding interior 26, one or more of the tube interiors 44, and (if included) one or more of the capillary interiors 70 at the first preform end 12. The outlet 126 can be a nozzle 126a, which distributes the gas 124 broadly into the cladding interior 26, the tube interiors 44, and the capillary interiors 70 (if included). In embodiments, the system 102 further includes a filter 130 for the gas 124. The filter 130 is in fluid communication between the source 128 of the gas 124 and the outlet 126. As mentioned, a purpose of the disclosure is to reduce contamination of the fiber preform 10, and the filter 130 can reduce the potential for such contamination. The gas 124 introduced into the outer preform cladding 18, one or more of the inner preform tubes 34, and one or more of the nested preform capillaries 58 (if included) at the first preform end 12 flows along the longitudinal axis 16 toward the second preform end 14 and then out of the outer preform cladding 18, the one or more of the inner preform tubes 34, and the one or more of the nested preform capillaries 58 (if included) at the second preform end 14.

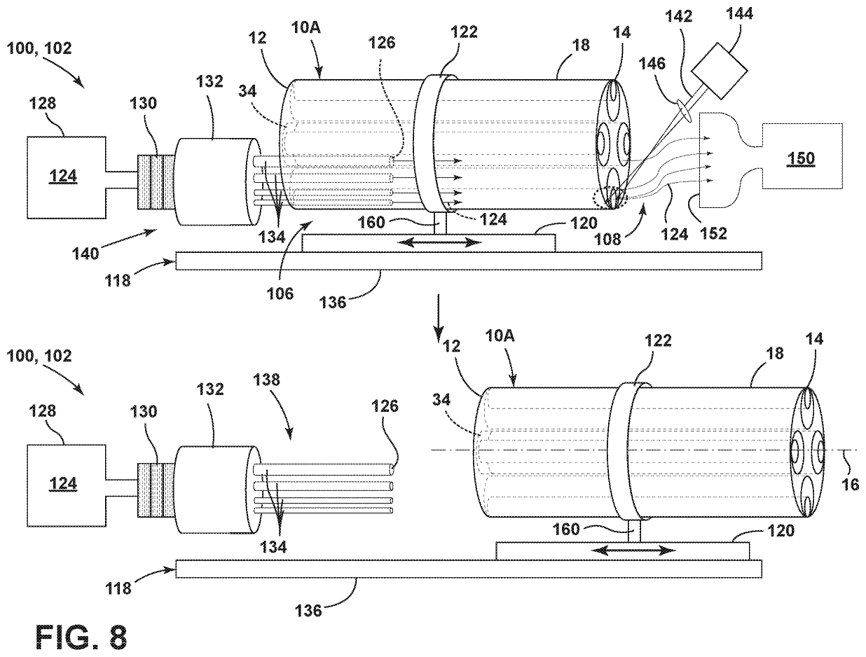

In embodiments (see FIG. 8), the system 102 further includes a manifold 132 to manipulate the gas 124 flow. The manifold 132 is in fluid communication with and between the source 128 of the gas 124 and the outlet 126. In such embodiments, the outlet 126 can include needles 134. Each of the needles 134 is in fluid communication with the manifold 132 and extends separately therefrom. The gas 124 that flows from the source 128 and into the manifold 132 thereafter flows into and through each of the needles 134. Each of the needles 134 is positioned to extend parallel to the longitudinal axis 16 of the fiber preform workpiece 10A. The system 102 can then further include a base mover 136. The base mover 136 is configured to move the base 120 and thus the fiber preform workpiece 10A relative to the needles 134 parallel to the longitudinal axis 16 so that the needles 134 transition to, from, and between a retracted position 138 and an inserted position 140. In the retracted position 138, the needles 134 do not extend into the fiber preform workpiece 10A. For example, in the retracted position 138, the needles 134 are disposed outside of the cladding interior 26, the tube interior 44 of each of the inner preform tubes 34, and the capillary interior 70 of each of the nester preform capillaries 58 (if included). However, in the inserted position 140, the needles 134 are disposed within one or more of those, such as at least the cladding interior 26 of the outer preform cladding 18 and the tube interior 44 of the inner preform tube 34 subjected to the laser welding step 108. The use of the needles 134 helps direct the flow of the gas 124 to where the fiber preform workpiece 10A may generate debris during the laser welding step 108. In addition, the needles 134 allows the flow of the gas 124 to bypass particles that might be existing already at the first preform end 12 so as to avoid causing the particles to flow toward and accumulate at the second preform end 14.

The composition of the gas 124 is not particularly important. Nitrogen and low humidity air are suitable examples. During the gas flow step 106, the gas 124 is caused to flow at a volumetric flow rate. The volumetric flow rate should be high enough to push debris generated during the laser welding step 108 and simultaneously be low enough to not interfere with a goal of the laser welding step 108 in generating the laser weld volume (as will be further discussed). In embodiments, during the gas flow step 106, the gas 124 is caused to flow at a volumetric flow rate within a range of from 1.0 LPM (liters per minute) to 5.0 LPM. For example, the volumetric flow rate during the gas flow step 106 can be 1.0 LPM, 1.5 LPM, 2.0 LPM, 2.5 LPM, 3.0 LPM, 3.5 LPM, 4.0 LPM, 4.5 LPM, 5.0 LPM, or within any range bound by any two of those values (e.g., from 2.5 LPM to 4.0 LPM, from 4.5 LPM to 5.0 LPM). The volumetric flow rate can be outside of the mentioned ranges-they are merely exemplary.

As mentioned, the method 100 includes the laser welding step 108 occurring simultaneously with the gas flow step 106. The laser welding step 108 includes directing a welding emission 142 from a laser 144 into the fiber preform workpiece 10A proximate the second preform end 14. The welding emission 142 increases temperature and reduces viscosity of the outer preform cladding 18 and one of the inner preform tubes 34 sufficiently for the laser 144 to form a laser weld volume 78 (here, one of the second laser weld volumes 78b) to form that fuses the outer preform cladding 18 and the inner preform tube 34 together. The system 102 further includes the laser 144. The laser 144 is configured to generate the welding emission 142. For example, the laser 144 can be a CO₂ laser, in which case the welding emission 142 has a wavelength of peak intensity within the mid-infrared region, or potentially an ultraviolet laser. Other wavelength options are possible. The laser 144 is positioned, either alone or in combination with focusing and/or reflecting optics 146 to direct the welding emission 142 into or onto one of the inner preform tubes 34 of the fiber preform workpiece 10A proximate the second preform end 14. In embodiments, the laser 144 and any focusing and/or reflecting optics 146 are positioned to emit the welding emission 142 at an angle 148 (see FIG. 6) relative to the tube axis 40 of the inner preform tube 34 that the welding emission 142 is affecting to form the laser weld volume 78. The angle 148 is preferably an acute angle. While beyond the scope of this disclosure, the welding emission 142 entering the material of the inner preform tube 34 and outer preform cladding 18 at the acute angle 148 can cause the laser weld volume 78 to form at an acute angle relative to the tube axis 40 as well, which can increase the strength of the laser weld volume 78.

In embodiments, during the gas flow step 106, a suction source 150 in fluid communication with a suction inlet 152 disposed proximate the second preform end 14 is activated and accepts the gas 124 that has flowed through the tube interior 44 of the inner preform tube 34 encountering the welding emission 142 and any other portion of the fiber preform workpiece 10A (e.g., the cladding interior 26). To accommodate, the system 102 can further include suction inlet 152 and the suction source 150 in fluid communication therewith. The suction inlet 152 is positioned to be proximate the second preform end 14 when the workpiece support 118 is supporting the fiber preform workpiece 10A. When the suction source 150 is activated, the suction inlet 152 draws in at least a portion of the gas 124 that has flowed from the outlet 126 from the source 128 of gas 124 flow through the tube interior 44 of the inner preform tube 34 encountering the welding emission 142 and any other portion of the fiber preform workpiece 10A. The suction inlet 152 can be disposed proximate where the welding emission 142 contacts the fiber preform workpiece 10A during the laser welding step 108. During the laser welding step 108, the welding emission 142 generates debris originating from the fiber preform workpiece 10A. The gas 124 flowing through the fiber preform workpiece 10A causes at least a portion of the debris to flow into the suction source 150. The gas 124 flowing toward the suction source 150 pulls the debris along with the gas 124 and helps reduced the amount of the debris that deposits back onto the fiber preform workpiece 10A.

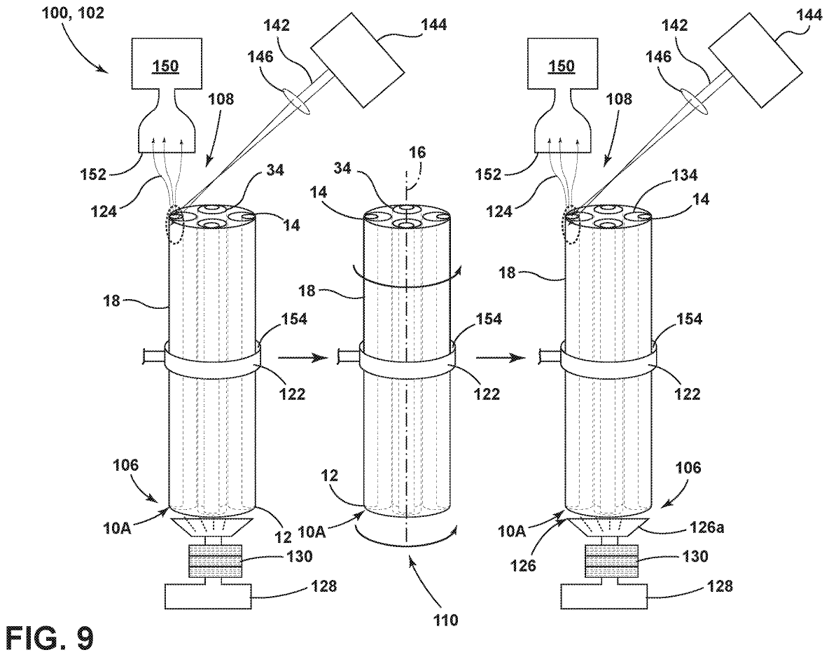

In embodiments, as mentioned, the method 100 further includes the workpiece azimuthal rotation step 116 (see FIG. 9). The workpiece azimuthal rotation step 116 occurs after a first performance of the gas flow step 106 and the laser welding step 108 that forms the laser weld volume 78 fusing one of the inner preform tubes 34 and the outer preform cladding 18 together. The fiber preform workpiece 10A will typically include more than one inner preform tube 34, and each can receive a laser weld volume 78 fusing it to the outer preform cladding 18. The workpiece azimuthal rotation step 116 includes rotating the fiber preform workpiece 10A azimuthally about the longitudinal axis 16. Assuming the laser 144 remains static, the workpiece azimuthal rotation step 116 results in the alignment of the next of the inner preform tubes 34 to be subjected to the laser welding step 108. To perform the workpiece azimuthal rotation step 116, the system 102 can further include an azimuthal rotation member 154. The azimuthal rotation member 154 is configured to rotate the fiber preform workpiece 10A azimuthally about the longitudinal axis 16 to align another one of the inner preform tubes 34 to receive a welding emission 142 from the laser 144. For example, the clamp 122 can include an inner track that is able to rotate and thereby rotate the fiber preform workpiece 10A. The inner track can be moved via a step motor.

After the workpiece azimuthal rotation step 116 has positioned the next of the inner preform tubes 34 correctly relative to the laser 144, the method 100 further includes a second performance of the gas flow step 106 and the laser welding step 108. The second performance of the laser welding step 108 results in the fusion of the outer preform cladding 18 and the newly positioned one of the inner preform tubes 34 together at a laser weld volume 78 (e.g., another one of the second laser weld volumes 78b). This sequence of workpiece azimuthal rotation step 116, laser welding step 108, and gas flow step 106 can be performed repeatedly until sufficient number of the laser weld volumes 78 (e.g., second laser weld volumes 78b) has been formed to fuse each of the inner preform tubes 34 to the outer preform cladding 18 at, for example, the second preform end 14.

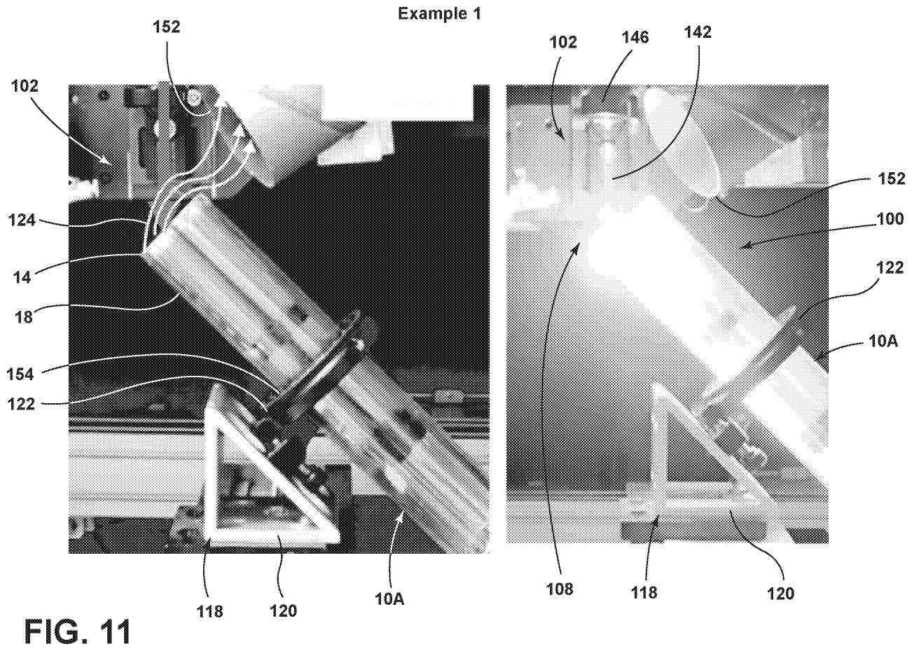

The workpiece support 118 can secure the fiber preform workpiece 10A so that the longitudinal axis 16 takes one of any number of positions during the workpiece azimuthal rotation step 116. For example, during the workpiece azimuthal rotation step 116, the longitudinal axis 16 can be oriented horizontally (see FIG. 6). As another example, during the workpiece azimuthal rotation step 116, the longitudinal axis 16 can be oriented vertically (see FIG. 9). Finally, during workpiece azimuthal rotation step 116, the longitudinal axis 16 is oriented at an angle between horizontal and vertical (see Example 1, FIG. 11).

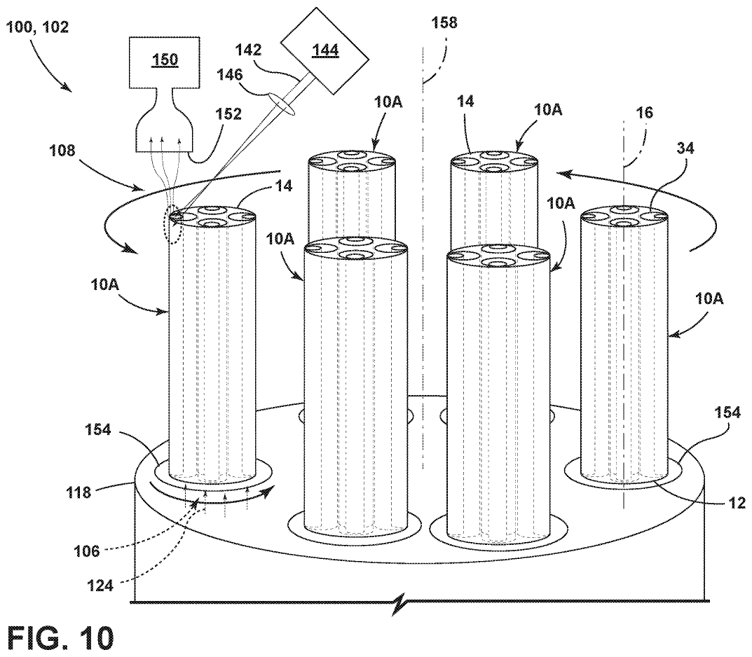

In embodiments (see FIG. 10), the workpiece support 118 is configured to support multiple fiber preform workpieces 10A. That way, the method 100 can be performed multiple times in sequence on the multiple fiber preform workpieces 10A to form multiple fiber preforms 10. Each of the multiple fiber preform workpieces 10A can be evenly spaced around a support axis 158. The support axis 158 is parallel to the longitudinal axis 16 of each of the fiber preform workpieces 10A. The workpiece support 118 is further configured, such as via an electric step motor, to rotate about the support axis 158 to place, in sequence, each of the multiple fiber preform workpieces 10A in position relative to the laser 144 to receive a welding emission 142. Further, the workpiece support 118 can include an azimuthal rotation member 154 dedicated to each of the multiple fiber preform workpieces 10A that the workpiece support 118 is supporting. For example, assume that workpiece support 118 supports six fiber preform workpieces 10A, and each of the fiber preform workpieces 10A includes four inner preform tubes 34, then the azimuthal rotation member 154 can facilitate repeated performances of the workpiece azimuthal rotation step 116, the gas flow step 106, and the laser welding step 108 until each of the four inner preform tubes 34 of the fiber preform workpiece 10A have fused to the outer preform cladding 18 (e.g., at the second preform end 14). Then the workpiece support 118 can rotate about the support axis 158 to align the next fiber preform workpiece 10A. Then again, the azimuthal rotation member 154 associated with the fiber preform workpiece 10A newly aligned can facilitate repeated performances of the workpiece azimuthal rotation step 116, the gas flow step 106, and the laser welding step 108 until each of the four (illustrated) inner preform tubes 34 of the fiber preform workpiece 10A newly aligned have fused to the outer preform cladding 18 (e.g., at the second preform end 14). That process can continue until each of the four inner preform tubes 34 have been fused to the outer preform cladding 18 of each of the six fiber preform workpieces 10A.

At this point in the discussion of the method 100 and the system 102, each of the inner preform tubes 34 has been subjected to a laser welding step 108 (and simultaneous gas flow step 106 to remove debris) to form a laser weld volume 78 fusing the inner preform tube 34 and the outer preform cladding 18 together at the second preform end 14 (e.g., with second laser weld volumes 78b). Each of the inner preform tubes 34 still could be fused to the outer preform cladding 18 at the first preform end 12 (e.g., with first laser weld volumes 78a).

As mentioned, in embodiments, the method 100 further includes the workpiece axial rotation step 110 (see FIG. 6 again). The workpiece axial rotation step 110 occurs after at least the gas flow step 106 and the laser welding step 108. The workpiece axial rotation step 110 could occur after all performances of the gas flow step 106 and the laser welding step 108 needed to fuse each of the inner preform tubes 34 to the outer preform cladding 18 at the second preform end 14 with the second laser weld volumes 78b. In any event, the workpiece axial rotation step 110 includes rotating the fiber preform workpiece 10A 180 degrees about an axis orthogonal to the longitudinal axis 16. Assuming that the components of the system 102 (e.g., the laser 144, the outlet 126, the suction inlet 152, etc.) stay static, the system 102 can rotate the fiber preform workpiece 10A so that the first preform end 12 of the fiber preform workpiece 10A is now properly aligned with the laser 144. For example, the clamp 122 of the system 102 can be coupled to the base 120 with a rotatable axle 160 driven by an electric motor. The rotatable axle 160 would be orthogonal to the longitudinal axis 16 of the fiber preform workpiece 10A.

After the workpiece axial rotation step 110, the method 100 further includes repeat performances of the gas flow step 106 and the laser welding step 108 to result in the formation of a first laser weld volume 78a that fuses one of the inner preform tubes 34 and the outer preform cladding 18 together at the first preform end 12. Stated more precisely, the method 100 further includes at least a second performance of the gas flow step 106 and a second performance of the laser welding step 108. The second performance of the gas flow step 106 can include introducing and causing the gas 124 to flow into at least the tube interior 44 of the inner preform tube 34 to be subjected to the laser welding step 108 and any other portion of the fiber preform workpiece 10A as desired such as the cladding interior 26 of the outer preform cladding 18 and the tube interior 44 of any other of the inner preform tubes 34 at the second preform end 14. The gas 124 thus flows toward the first preform end 12. The second performance of the laser welding step 108, occurring simultaneously with the second performance of the gas flow step 112, includes directing a second welding emission 142 from the laser 144 into the fiber preform workpiece 10A proximate the first preform end 12. More particularly, the second welding emission 142 is directed into or onto one of the inner preform tubes 34 and/or the outer preform cladding 18. The second welding emission 142 increases temperature and reduces viscosity of the inner preform tube 34 and the outer preform cladding 18 sufficiently for the first laser weld volume 78a to form that fuses the inner preform tube 34 and the outer preform cladding 18 together at the first preform end 12. Thereafter, the workpiece azimuthal rotation step 116 and subsequent repeat performances of the gas flow step 106 and the laser welding step 108 can be performed as necessary to form sufficient of the first laser weld volumes 78a to fuse all of the inner preform tubes 34 and the outer preform cladding 18 together at the first preform end 12. The workpiece support 118, if supporting multiple fiber preform workpieces 10A, can rotate to place the next fiber preform workpiece 10A in alignment with the laser 144 to fuse all of the inner preform tubes 34 of that fiber preform workpiece 10A to the outer preform cladding 18, and so on. One or more of the fiber preforms 10 is thus made.

The method 100 and the system 102 of the present disclosure address the problems set forth in the Background in a variety of ways. Conducting the gas flow step 106 simultaneously with the laser welding step 108 lessens the ability of particles released during the laser welding step 108 to deposit back onto components of the fiber preform workpiece 10A, such as the inner cladding surface 24 of the inner tube surface 42 being subjected to the laser welding step 108. As the laser welding step 108 causes the fiber preform workpiece 10A to release particles, the particles flow with the gas 124 out of the tube interior 44 and the cladding interior 26 and into the suction inlet 152. The laser weld volume 78 still forms to fuse the inner preform tube 34 to the outer preform cladding 18 but with less deposition of particles. Thus, there is no need for the costly and difficult remediation efforts to remove the particles-the particles are not there. Further, any possible distortion of components of the fiber preform workpiece 10A resulting from use of the open flame to fuse the components is avoided, because fusion takes placed via the welding emission 142 from the laser 144.

### EXAMPLES

Example 1—For Example 1, a system to manufacture a fiber perform from a fiber preform workpiece was assembled with a workpiece support including a base and a clamp extending from the base. The clamp extended entirely around the outer cladding surface of the outer preform cladding. The longitudinal axis of the fiber preform workpieces was at an angle of about 45 degrees from horizontal. The system further included a laser positioned to emit a welding emission into one of the inner preform tubes at the second preform end and also at an angle of about 45 degrees but this time relative to the longitudinal axis of the fiber preform. The system further included a suction inlet in communication with a source of suction disposed proximate where the second preform end would be and the laser welding would occur. The system further included an outlet for gas flow to enter into the cladding interior and the tube interior of the inner preform tube that was positioned to receive the welding emission from the laser.

The method of the present disclosure was then conducted with the gas flow step taking place simultaneously with the laser welding step. The flow of the gas caused debris ejected from the inner preform tube to flow with the gas out of the tube interior and into the suction inlet. Images were captured before the laser welding step began (left) and as the laser welding step was occurring (right). Those images are reproduced at FIG. 11.

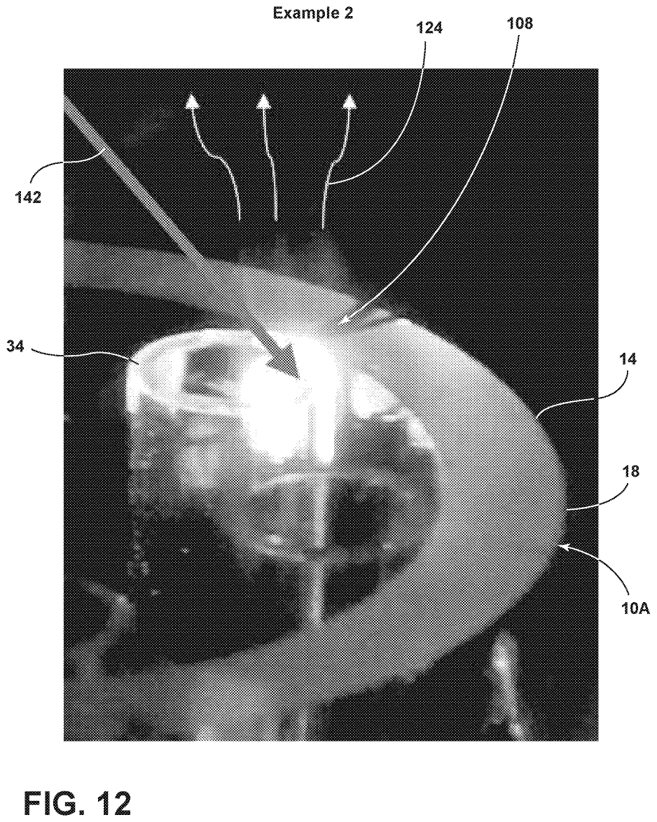

Example 2—For Example 2, the same system and method described above for Example 1 was used to support and subject a fiber preform workpiece to the gas flow step simultaneously with the laser welding step, with the exception that the support held the fiber preform workpiece with the longitudinal axis oriented vertically. Debris ejected from the inner preform tube entered into the gas flow, out of the tube interior, and into the suction inlet. An images was captured as the method was occurring. The image is reproduced at FIG. 12. Notably, the image shows debris with the gas flow heading toward the suction inlet.

It will be apparent to those skilled in the art that various modifications and variations can be made without departing from the spirit or scope of the claims.

What is claimed is:

1. A method of manufacturing a fiber preform comprising:
a gas flow step comprising introducing gas to flow through a fiber preform workpiece at a first preform end of the fiber preform workpiece, the fiber preform workpiece comprising inner preform tubes disposed within an outer preform cladding, the fiber preform workpiece further comprising a second preform end and a longitudinal axis extending from the first preform end to the second preform end; and
a laser welding step, occurring simultaneously with the gas flow step, the laser welding step comprising directing a welding emission from a laser into the fiber preform workpiece proximate the second preform end, the welding emission increasing temperature and reducing viscosity of the outer preform cladding and one of the inner preform tubes sufficiently for a laser weld volume to form that fuses the outer preform cladding and the one of the inner preform tubes together.

2. The method of claim 1, wherein
the fiber preform workpiece further comprises nested preform capillaries, each of the nested preform capillaries disposed within a different one of the inner preform tubes, and
during the gas flow step, the gas is introduced to flow through one or more of the outer preform cladding, the inner preform tubes, and the nested preform capillaries.

3. The method of claim 2, wherein
the outer preform cladding has a cladding thickness,
each of the inner preform tubes has a tube thickness,
each of the nested preform capillaries has a capillary thickness, and
the cladding thickness is greater than both the tube thickness and the capillary thickness.

4. The method of claim 1, wherein the outer preform cladding and the inner preform tubes all comprise one or more of silica, doped silica, fluorine-doped silica, fluorine-doped borosilicate glass, borosilicate glass, soda-lime glass, and aluminosilicate glass.

5. The method of claim 1, wherein during the gas flow step, the gas is caused to flow at a volumetric flow rate within a range of from 1.0 liters per minute to 5.0 liters per minute.

6. The method of claim 1, wherein during the gas flow step, the gas is caused to flow (i) into the fiber preform workpiece at the first preform end, (ii) along the longitudinal axis toward the second preform end, and (iii) out of the fiber preform workpiece at the second preform end.

7. The method of claim 1, wherein during the gas flow step, a source of suction with a suction inlet disposed proximate the second preform end is activated and accepts the gas that has flowed through the fiber preform workpiece.

8. The method of claim 7, wherein during the laser welding step, the welding emission generates debris originating from the fiber preform workpiece, and the gas flowing through the fiber preform workpiece causes at least a portion of the debris to flow into the source of suction.

9. The method of claim 1, further comprising:
a workpiece azimuthal rotation step, occurring after a first performance of the gas flow step and the laser welding step, the workpiece azimuthal rotation step comprising rotating the fiber preform workpiece azimuthally about the longitudinal axis; and
a second performance of the gas flow step and the laser welding step, the second performance of the laser welding step resulting in the fusion of the outer preform cladding and a different one of the inner preform tubes together at a laser weld volume different than the laser weld volume at which the inner preform tube is fused to the outer preform cladding as a result of the first performance.

10. The method of claim 9, wherein during the workpiece azimuthal rotation step, the longitudinal axis is oriented horizontally.

11. The method of claim 9, wherein during the workpiece azimuthal rotation step, the longitudinal axis is oriented vertically.

12. The method of claim 9, wherein during workpiece azimuthal rotation step, the longitudinal axis is oriented at an angle between horizontal and vertical.

13. The method of claim 1, further comprising:
a workpiece axial rotation step, occurring after the gas flow step and the laser welding step, the workpiece axial rotation step comprising rotating the fiber preform workpiece 180 degrees about an axis orthogonal to the longitudinal axis;
a second performance of the gas flow step comprising introducing the gas at the second preform end to flow through the fiber preform workpiece; and
a second performance of the laser welding step, occurring simultaneously with the second gas flow step, the second laser welding step comprising directing a second welding emission from the laser into the fiber preform workpiece proximate the first preform end, the second welding emission increasing temperature and reducing viscosity of the outer preform cladding and one of the inner preform tubes sufficiently for a first laser weld volume to form that fuses the outer preform cladding and the inner preform tube together at the first preform end.

14. A system for manufacturing a fiber preform comprising:
a workpiece support configured to support a fiber preform workpiece, the fiber preform workpiece comprising
a first preform end, a second preform end, and a longitudinal axis extending from the first preform end to the second preform end;
an outer preform cladding through which the fiber longitudinal axis extends, the outer preform cladding comprising an inner cladding surface facing and disposed radially around the longitudinal axis; and
inner preform tubes coupled to the outer preform cladding at the inner cladding surface of the outer preform cladding, each of the inner preform tubes comprising (i) a tube axis extending therethrough parallel to the longitudinal axis of the fiber preform workpiece, (ii) an inner tube surface extending radially around the tube axis, and (iii) an outer tube surface facing away from the tube axis, and wherein the inner preform tubes collectively defining a preform core that extends radially from the longitudinal axis and that is tangential to the outer tube surface of each of the inner preform tubes;
a laser configured to generate a welding emission, the laser positioned to direct the welding emission into one of the inner preform tubes of the fiber preform workpiece proximate the second preform end; and
at least one of:
an outlet in fluid communication with a source of gas, the outlet positioned to
introduce gas of the source of gas to flow through one or more of the outer preform cladding and the inner preform tubes of the fiber preform workpiece at the first preform end; and
a suction inlet in fluid communication with a source of suction, the suction inlet
positioned to be proximate the second preform end and, when activated, to draw in at least a portion of the gas that has flowed through the one or more of the outer preform cladding and the inner preform tubes.

15. The system of claim 14, further comprising:
a filter in fluid communication with and between the source of the gas and the outlet.

16. The system of claim 14, further comprising:
a manifold in fluid communication with and between the source of the gas and the outlet;
needles in fluid communication with the manifold, each of the needles positioned to extend parallel to the longitudinal axis of the fiber preform workpiece and collectively defining the outlet; and
a base mover configured to move the base of the workpiece support relative to the needles parallel to the longitudinal axis of the fiber preform workpiece so that the needles transition to, from, and between (i) a retracted position where the needles do not extend into the fiber preform workpiece and (ii) an inserted position where the needles are disposed within one or more of a cladding interior of the outer preform cladding and a tube interior of the inner preform tube subjected to the laser welding step.

17. The system of claim 14, wherein the laser is positioned to emit the welding emission at an acute angle relative to the tube axis of the inner preform tube that the welding emission is affecting to form the laser weld volume.

18. The system of claim 14, further comprising:
both (i) the outlet and (ii) the suction inlet in fluid communication with the source of suction.

19. The system of claim 14, wherein the workpiece support comprises an azimuthal rotation member that is configured to rotate the fiber preform workpiece azimuthally about the longitudinal axis to align another one of the inner preform tubes to receive a welding emission from the laser.

20. The system of claim 14, wherein the workpiece support is configured (i) to support multiple fiber preform workpieces, each of the multiple fiber preform workpieces evenly spaced around a support axis and (ii) to rotate about the support axis to place, in sequence, each of the multiple fiber preform workpieces in position relative to the laser to receive a welding emission.
